(19) United States
(12) Patent Application Publication
(10) Pub. No.: US 2020/0320520 A1
(43) Pub. Date: Oct. 8, 2020

(54) Systems and Methods for Monitoring Performance of Payment Networks Through Distributed Computing

(71) Applicant: MASTERCARD INTERNATIONAL INCORPORATED, PURCHASE, NY (US)

(72) Inventors: Navjot Singh Sidhu, White Plains, NY (US); Craig Hibbeler, Ballwin, MO (US); Vijayanath K. Bhuvanagiri, Wildwood, MO (US); Revaz Tsivtsivadze, New York, NY (US); Narendra Dukkipati, Dardenne Prairie, MO (US)

(21) Appl. No.: 16/908,205

(22) Filed: Jun. 22, 2020

Related U.S. Application Data
(63) Continuation of application No. 14/640,535, filed on Mar. 6, 2015.
(60) Provisional application No. 62/025,286, filed on Jul. 16, 2014.

(51) Int. Cl. G06Q 20/38; G06Q 20/40

(52) U.S. Cl. CPC G06Q 20/38; G06Q 20/4016

(57) ABSTRACT

Systems and methods for use in monitoring performance of payment networks through use of distributed computing. One example method includes generating metrics and/or events associated with a deployed region of the agent, correlating the metrics and/or events over at least one time interval, the time interval dependent on at least one of historical data related to the deployed region and a known event, detecting, at the agent, at least one variance in the metrics and/or events over the at least one time interval based on a statistical analysis with at least one tolerance, and publishing sampled data, to an associated collector, based on at least one of a sampling rule and the at least on variance.

### CROSS-REFERENCE TO RELATED APPLICATIONS

This application is a continuation of U.S. patent application Ser. No. 14/640,535 filed Mar. 6, 2015, which claims the benefit of and priority to U.S. Provisional Application No. 62/025,286 filed on Jul. 16, 2014. The entire disclosure of each of the above applications is incorporated herein by reference.

### FIELD

The present disclosure generally relates to systems and methods for use in monitoring performance of payment networks through use of distributed computing.

### BACKGROUND

This section provides background information related to the present disclosure which is not necessarily prior art.

A variety of data transfers occur within a payment network to permit transactions for the purchase of products and services. These data transfers ensure that payment accounts to which transactions are to be posted are in good standing to support the transactions. When issues arise within a payment network, the source of the issues may involve any participant of the payment network including, for example, computing devices associated with entities directly involved in the data transfers (e.g., issuers, payment service providers, acquirers, etc.).

### DRAWINGS

The drawings described herein are for illustrative purposes only of selected embodiments and not all possible implementations, and are not intended to limit the scope of the present disclosure.

FIGS. 1A-1D are sectional block diagrams of an exemplary system of the present disclosure suitable for use in monitoring performance of payment networks; and

FIG. 2 is a block diagram of a computing device that may be used in the exemplary system of FIGS. 1A-1D.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

A payment network is made up of a variety of different entities, and computing devices associated with those entities. The computing devices cooperate to transfer data to enable payment transactions to be completed, such that efficiency of the data transfers impacts the speed with which consumers are able to complete purchases. When issues associated with the transactions arise within the payment network, determining the precise computing devices and/or groups of computing devices responsible for the issues, and then resolving the issues, is difficult. The systems and methods herein distribute analysis of the payment network to at least a portion of the computing devices included in the network. The distributed analysis utilizes available processing, at the distributed computing devices, to segregate the analysis of the payment network to lower levels (e.g., to levels near the source of the data being transferred, etc.) and pull up variances to higher levels, thereby providing efficient collection and processing of large diverse data sets with a high degree of sparse dimensionality. In this manner, degraded parts of the payment network are identified in real time, which permits remedial action and/or proactive mitigation to reduce the effect of those parts on network performance.

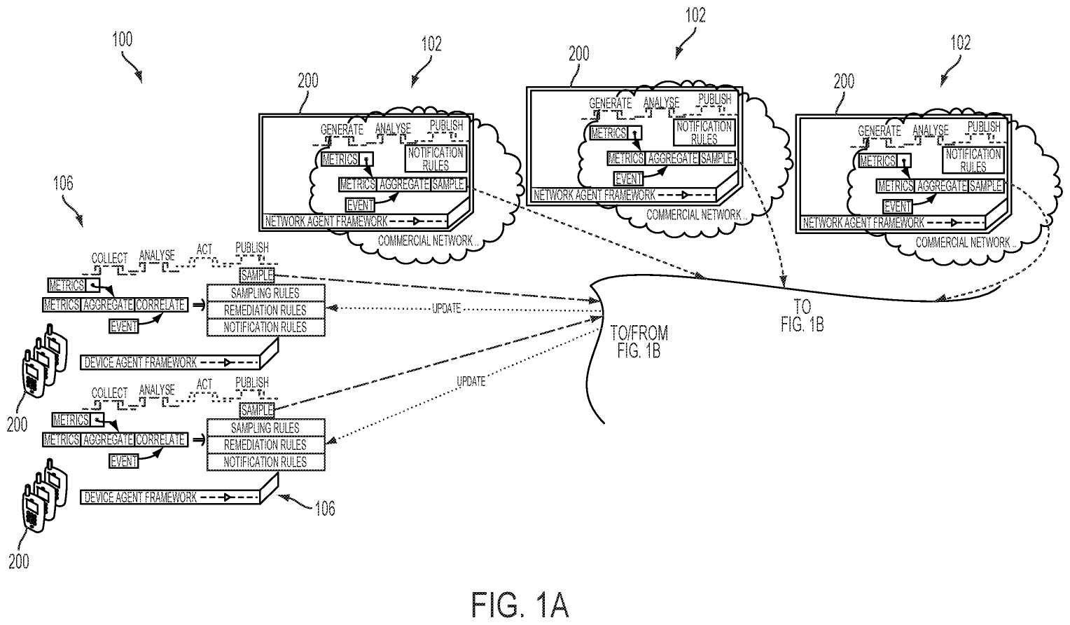

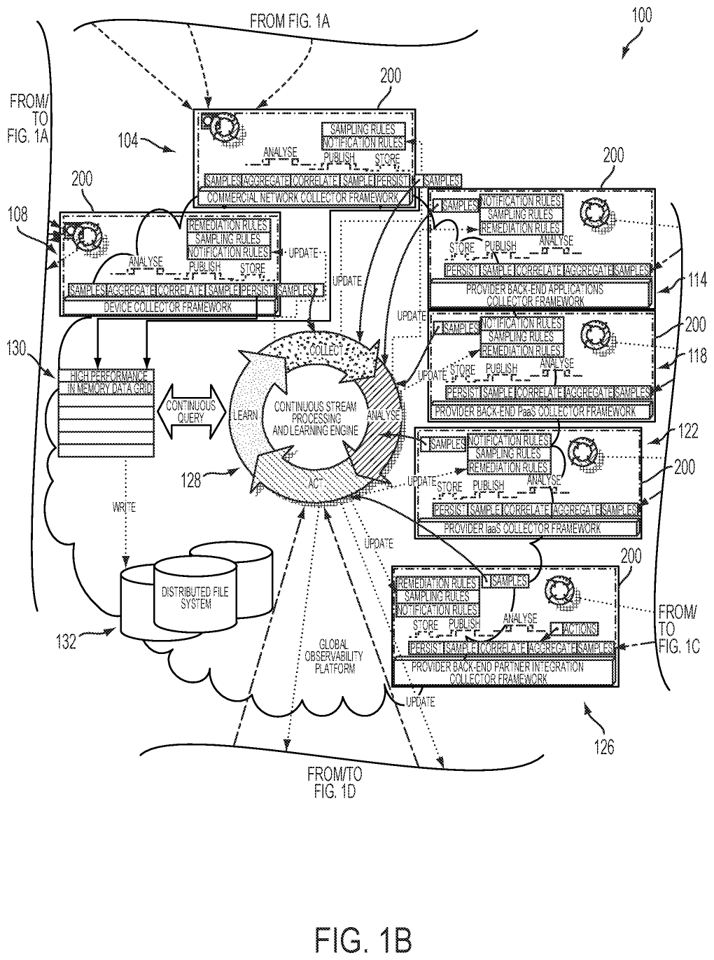

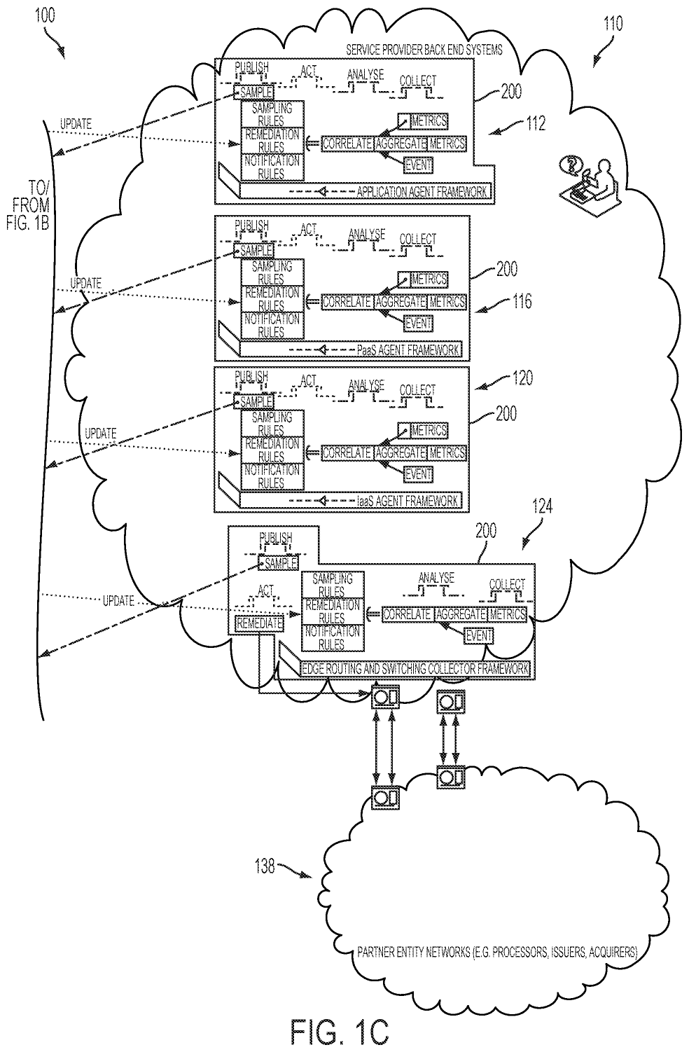

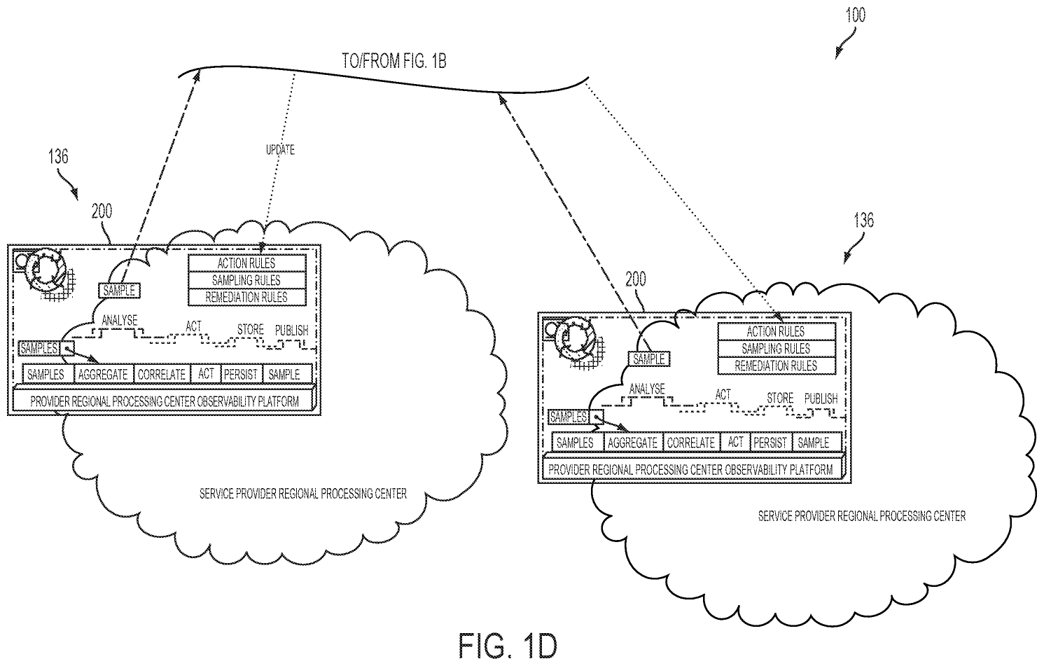

FIGS. 1A-1D illustrate an exemplary system 100, in which the one or more aspects of the present disclosure may be implemented. Although, in the described embodiment, components/entities of the system 100 are presented in one arrangement, other embodiments may include the same or different components/entities arranged otherwise. In addition, while the illustrated system 100 is described as a payment network, in at least one other embodiment, the system 100 is suitable to perform processes unrelated to processing payment transactions.

The system 100 generally includes multiple commercial network agents 102, multiple device agents 106, a service provider backend system 110, a processing engine 128, and multiple regional processing engines 136. The backend system 110 includes an application agent 112, a Platform as a Service (PaaS) agent 116, an Infrastructure as a Service (IaaS) agent 120, and an edge routing and switching collector 124. The processing engine 128 includes a network collector 104, a device collector 108, a backend application collector 114, a backend PaaS collector 118, a backend IaaS collector 122, and a backend partner integration collector 126. In addition, the processing engine 128 includes a data grid 130 and a distributed file system 132.

The system 100 further includes and/or communicates with partner entity networks 138. Such partner entity networks can include, for example, those networks associated with processors, acquirers, and issuers of payment transactions; etc.

In addition, the system 100 utilizes, in connection with one or more of the components/entities illustrated in FIGS. 1A-1D, and as described in more detail below, one or more of: real time analysis, end-to-end user experience observability, dynamic end-to-end system component discovery, real time system behavior regression analysis, real time pattern detection and heuristics based predictive analysis, real time automated system management and re-configuration, real time automatic traffic routing, and real time protection against security breaches and fraud/theft, etc.

It should be appreciated that each of the components/entities illustrated in the system 100 of FIGS. 1A-1D includes (or is implemented in) one or more computing devices, such as a single computing device or multiple computing devices located together, or distributed across a geographic region. The computing devices may include, for example, one or more servers, workstations, personal computers, laptops, tablets, PDAs, point of sale terminals, smartphones, etc.

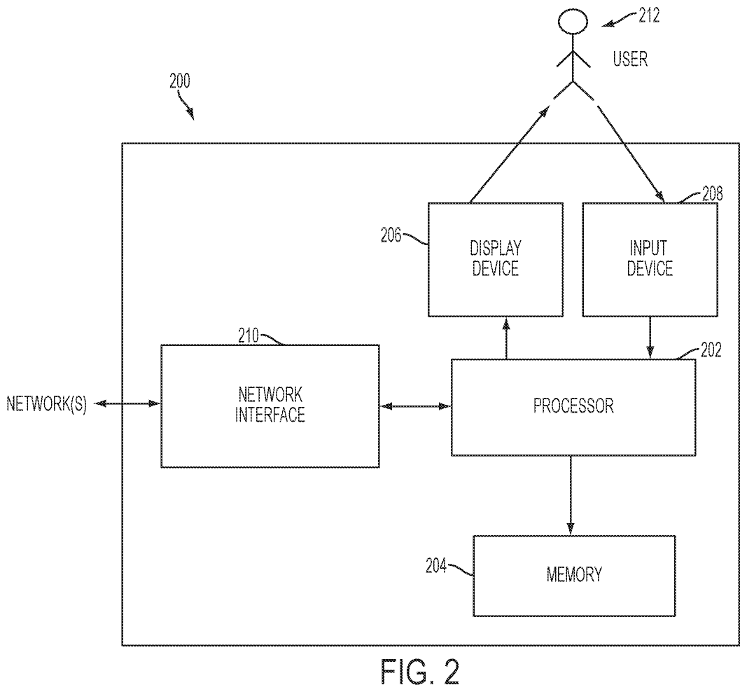

For illustration, the system 100 is described below with reference to an exemplary computing device 200, as illustrated in FIG. 2. The system 100, and the components/entities therein, however, should not be considered to be limited to the computing device 200, as different computing devices, and/or arrangements of computing devices may be used in other embodiments.

As shown in FIG. 2, the exemplary computing device 200 generally includes a processor 202, and a memory 204 coupled to the processor 202. The processor 202 may include, without limitation, a central processing unit (CPU), a microprocessor, a microcontroller, a programmable gate array, an application-specific integrated circuit (ASIC), a logic device, or the like. The processor 202 may be a single core, a multi-core processor, and/or multiple processors distributed within the computing device 200. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, metrics, events, variances, samplings, remediation and/or notification rules, and/or other types of data suitable for use as described herein.

In the exemplary embodiment, computing device 200 also includes a display device 206 that is coupled to the processor 202. Display device 206 outputs to a user 212 by, for example, displaying and/or otherwise outputting information such as, but not limited to, variances, notifications of variances, and/or any other type of data, often related to the performance of system 100. Display device 206 may include, without limitation, a cathode ray tube (CRT), a liquid crystal display (LCD), a light-emitting diode (LED) display, an organic LED (OLED) display, and/or an “electronic ink” display. In some embodiments, display device 206 includes multiple devices. It should be further appreciated that various interfaces (e.g., graphical user interfaces (GUI), webpages, etc.) may be displayed at computing device 200. The computing device 200 also includes an input device 208 that receives input from the user 212. The input device 208 is coupled to the processor 202 and may include, for example, a keyboard, a pointing device, a mouse, a stylus, a touch sensitive panel (e.g., a touch pad or a touch screen, etc.), card reader, swipe reader, touchscreen, and/or an audio input device.

The computing device 200 further includes a network interface 210 coupled to the processor 202, which permits communication with one or more networks. The network interface 210 may include, without limitation, a wired network adapter, a wireless network adapter, a mobile telecommunications adapter, or other device capable of communicating to one or more different networks, including the cloud networks interconnecting the entities shown in FIGS. 1A-1D, etc.

The computing device 200, as used herein, performs one or more functions, which may be described in computer executable instructions stored on memory 204 (e.g., a computer readable media, etc.), and executable by one or more processors 202. The computer readable media is a non-transitory computer readable media. By way of example, and without limitation, such computer readable media can include RAM, Read-only memory (ROM), Electrically Erasable Programmable Read-Only Memory (EEPROM), CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

Referring again to FIGS. 1A-1D, and particularly to FIG. 1A, each of the multiple network agents 102 of the system 100 is deployed in a commercial network in one or more regions (as represented by the clouds). In addition, each of the network agents 102 is also illustrated as implemented in a computing device 200. As shown in FIG. 1A, the network agents 102, in this exemplary embodiment, are each deployed to the computing device 200, which is associated with a payment service provider for the system 100, etc.

Each of the network agents 102 participates in data transfers and, more particularly in this exemplary embodiment, in data transfers related to payment transactions to payment accounts (although such data transfers need not be limited to those associated with financial transactions, and may be associated with other transactions). As the data transfers are executed, the network agents 102 generate performance information in the form of events and/or metrics (for example, events based on metrics, etc.) related to, for example, real-time network latency for one or more of the different geographic regions, real-time network availability for one or more of the different geographic regions, real-time bandwidth availability for one or more of the different regions, etc. It should be appreciated that the network agents 102, in one or more other embodiments, may generate different types of performance information, including different metrics and/or different events.

The network agents 102 aggregate the metrics and/or events associated with the data transfers over flexible time intervals, which are based on observed metrics. The number and duration of the flexible time intervals are determined, by the network agents 102 (or by other agents, collectors, engines, as appropriate), based on historical transfer data and/or known conditions, either inside or outside the system 100. As an example, different numbers of payment transactions to each the regions of the system 100, associated with the various network agents 102, may be expected during particular time intervals (e.g., during time intervals between 5:00 PM and 7:00 PM, as compared to between 3:00 AM and 4:30 AM, etc.) based on the historical transfer data. Further, different numbers of transactions to the regions of the system 100 may be expected during one or more particular conditions, such as, for example, during a championship sports event in a geographic region of the system 100, etc. As can be seen, network traffic can vary within the time intervals for one or more different reasons, and the system 100 is operable to correlate metrics and/or events within the flexible time intervals.

The network agents 102 then correlate the metrics and/or events over the flexible time intervals. The correlation involves the network agents 102 defining statistically significant dependencies and relationships between any set of metrics and/or events. For example, significant dependencies between two or more events include those that, based on probability theory, mean that the occurrence of one does not impact the others. The dependencies may be linear, in some examples, (e.g., the effect of lower network bandwidth can cause slower response times for the application, etc.), or non-linear in other examples.

Further, the network agents 102 analyze and detect variances (including, for example, anomalies, etc.) in the metrics and/or events over the time intervals, based on statistical analysis with tolerances defined through observed metrics. The tolerances are often specific to particular time intervals, and may vary depending on a number of variables including, for example, historical performance data for a particular commercial network and/or region, etc. In some examples, the tolerances may be based on standard deviations in the data sets and applied to moving averages over the time intervals in question. In particular, in one example, a tolerance may be about 1.5 standard deviations above and/or below the moving average for a particular time interval.

Through use of these tolerances, the network agents 102, through the system 100, employ a more dynamic analysis approach (i.e., use dynamic variance tolerances), as compared to analysis based on static thresholds. In traditional approaches, static thresholds are pre-determined and often arbitrarily based on a human projection on expected values for parameters at the high end. In some cases, for some of the metrics like memory utilization (only as an example here) these may be determined through testing in a different environment than the real operating environment. The issue with these traditional approaches is that the projections are, in a vast majority of the cases, overly conservative and in some cases purely based on some deciding before the system is built on how it will work or behave or be used. Thus, as can be appreciated, the dynamic approach utilized in the system 100 is much improved.

With additional reference to FIG. 1B, the network agents 102 also publish (individually, collectively, etc.) data gathered about the data transfers to the network collector 104 of the processing engine 128 (e.g., via computing devices 200, etc.). Publishing the data includes, for example, transmitting the data to a collector (or engine), designating the particular data, whereby it may be retrieved and/or collected by a collector (or engine), or other transaction by which the data is available to the collector. For example, the network agent 102, in publishing data, may transmit the data to the network collector 104, or simply make the data accessible to the network collector 104, such that the network collector is able to retrieve the data. The transmitted data may include, for example, the metrics and/or events generated by the network agents 102 (within their corresponding region, etc.), or more likely, a subset of the metrics and/or events. In some aspects, the network agents 102 further alter frequency and/or content of data sampling (e.g., in connection with the data transfers, etc.) based on one or more sampling rules (as shown), and the variances detected and/or analyzed by the network agents 102. For example, the rate at which the network agents 102 sample data may be increased and/or decreased based on occurrence of one or more variances, for example, such that higher frequencies or data contents may be published to the network collector 104 at different intervals (e.g., at 20 second intervals, as compared to 60, 90, or 120 second intervals when no variances are detected; etc.).

As can be seen, the network agents 102 are thus active in the analysis of the data transfer within their regions and/or parts of the system 100. As such, less processing and/or analysis may be required at different levels, including higher levels, of the system 100. The analysis performed by the network agents 102 utilizes local processing assets, within the distributed devices, such that the analysis can be done at the data source, with only certain variances published to higher levels of the system 100 (i.e., such that the network agents 102 are not continuously publishing all metrics and events).

With reference again to FIG. 1A, the device agents 106 of the system 100 also each include a computing device 200 (e.g., are implemented in a computing device 200, etc.), which is often associated with a consumer and/or a merchant, and which is used to complete one or more transactions to a payment account. The device agents 106 may be generic to the consumer and/or merchant, or may be configured specifically to a particular consumer and/or a particular merchant. Example computing devices, in which the device agents 106 may be deployed, include, for example, point of sale terminals, mobile devices/applications, smart watches, wearable devices, smart devices in a home or business (e.g., a television, a refrigerator, etc.), and/or any other one or more devices involved at the end users where transactions are initiated and/or completed, etc.

The device agents 106 generate (individually, collectively, etc.) time series metrics that include, for example, response times, resource utilizations, success/failure rates of transactions (e.g., business transactions, etc.), user actions, user-interface navigations (e.g., offer impressions, acceptances, etc.), etc. In addition, the device agents 106 also register and/or sample any sparse dimensional metrics, including, for example, transactions by one or more of currency, region, merchant, geo-location, financial instrument, authentication method, etc. Here, for example, the metrics are sampled, captured and/or aggregated along flexible, learned time intervals (however, they could be sampled differently within the scope of the present disclosure).

Based on the generated metrics, the device agents 106 then generate events, and correlate the metrics and/or events over the flexible moving time intervals based on observed metrics. This correlation involves the device agents 106 defining statistically significant dependencies and relationships between one or more sets of metrics and/or events. Like the network agents 102, the device agents 106 then analyze and detect variances in the metrics and/or events over the time intervals. Such variances may include, for example, variances in the screen load times for a mobile application that is attributable to the local processing on a device, variances in application startup time, variances in end-to-end response time as experienced by an end user, etc. It should be appreciated that the device agents 106, in some embodiments, may also receive events from external sources to inform them of the observed metrics of the system 100 and, in some aspects, particularly the parts of the system 100 associated with the particular device agents 106. These external sources are often trusted sources.

After processing the metrics and/or events as just described, the device agents 106 then apply one or more rules to the aggregated and correlated metrics and/or events. In the illustrated embodiment, the device agents 106 may include and/or apply rules that include, without limitation: sampling rules indicating whether or not metrics/events should be sent upstream for additional processing, remediation rules to determine what actions should be taken to address observed variances, notification rules to determine whether to raise alerts for specific observed variances to the system 100 or to user interfaces associated therewith, other rules that relate to one or more responses to the aggregated and/or correlated metrics and/or events in the device agents 106, etc. An example sampling rule includes sampling ten percent of overall traffic based on a request type dimension (e.g., a POST request, a GET request, etc.). An example notification rule includes publishing a notification in cases of over a two standard deviation variance in request timeout (e.g., http 500 response codes, etc.) counts over two consecutive sampling periods. An example remediation rule includes checking for application versions and initiating requests to users to get and install a specific (or maybe latest) version of an application. Based on at least one of the rules, the device agents 106 sample the metrics and/or events and publish the sampled data to the device collector 108 of the processing engine 128 (e.g., via computing devices 200, etc.) (FIG. 1B), upstream in the hierarchy of the system 100.

As an example, when the one or more rules applied by the device agent 106 include remediation rules, the device agent 106 may alter its operation to provide a safe operational state by, for example, suspending all non-transactional tasks until a particular transaction is complete (e.g., a current transaction, etc.). Further, the device agent 106 may provide a prompt to a user (e.g., user 212, etc.) associated with the action to achieve a safe operational state and/or may implement a suspension of one or more other tasks. The altered operation is limited to the computing device 200 in which the device agent 106 is deployed, but is published to the device collector 108 to permit patterns of metrics and/or events (or other actions) to be observed, and the rules relating to the remedial action to be dynamically altered in response thereto, as desired.

Referring now to FIG. 1C, the service provider backend system 110 of the system 100 includes, as described above, the application agent 112, the PaaS agent 116, the IaaS agent 120, and the edge routing and switching collector 124. Each includes (e.g., is illustrated as implemented in, etc.) a computing device 200.

The application agent 112 of the service provider backend system 110 is deployed in association with applications and services, such as, for example, transaction authorization services, etc. The application agent 112 generates time series metrics that may include (without limitation) response times, transactions per second, error/failure rates, etc. Other metrics may be generated by the application agent 112 based on application activities, etc. as desired. The application agent 112 also raises (or generates) application events, when unsafe states/conditions exist, such as, for example, unhandled exceptions, etc.

The generated metrics and/or events are captured by the application agent 112, and aggregated along flexible, learned time intervals, again based on observed metrics. In addition, the generated metrics and/or events may be correlated by the application agent 112 via defining statistically significant dependencies and relationships between one or more sets of the metrics and/or the events. The application agent 112 further analyzes and detects variances in the metrics and/or events over the time intervals based on statistical analysis, with dynamic thresholds computed through observed metric streams for the given class of infrastructure.

Data from the aggregation and correlation of the generated metrics and/or events is next checked, by the application agent 112, against one or more rules. These rules may again include, without limitation, sampling rules, remediation rules, and/or notification rules. The application agent 112 samples the data and publishes the sampled data to the provider backend application collector 114 of the processing engine 128 (e.g., via the computing devices 200, etc.) (FIG. 1B). In this manner, as with the network agents 102 and the device agents 106, data analysis is completed by the application agent 112 locally to distribute the processing involved in the analysis and promote more rapid analysis of the transfer data at the source of the data.

As an example, when the one or more rules applied by the application agent 112 include remediation rules, the application agent 112 may alter its operation to provide a safe operational state by, for example, rebooting when an Error No Memory (ENOMEM) event is detected, etc. In this example, the reboot may be limited to the computing device 200 in which the application agent 112 is deployed, but is published to the provider backend application collector 114 to permit patterns of events and actions to be observed and rules relating to the remedial actions to be dynamically altered in response thereto, as desired.

The PaaS agent 116 of the service provider backend system 110 is deployed in association with platform level services, such as, for example, enterprise service busses (ESBs), messaging systems, etc. The PaaS agent 116 generates time series metrics that may include (without limitation) response times, resource utilizations, etc. Other metrics may be generated by the PaaS agent 116 based on platform level activities, etc. as desired. The PaaS agent 116 also raises (or generates) PaaS events, when unsafe states/conditions exist, such as, for example, request queue exhaustions, high garbage collection counts, etc.

The generated metrics and/or events are captured by the PaaS agent 116, and aggregated along flexible, learned time intervals based on observed metrics. In addition, the generated metrics and/or events are correlated by the PaaS agent 116 by defining statistically significant dependencies and relationships between one or more sets of the metrics and/or the events. The PaaS agent 116 then analyzes and detects variances in the metrics and/or events over the time intervals based on statistical analysis, with dynamic thresholds again computed through observed metric streams for the given class of infrastructure.

The data from the aggregation and correlation of the generated metrics and/or events is next checked, by the PaaS agent 116, against one or more rules. The rules again may include, without limitation, sampling rules, remediation rules, and/or notification rules. The PaaS agent 116 samples the data from the analysis and publishes the sampled data to the provider backend PaaS collector 118 of the processing engine 128 (e.g., via the computing devices 200, etc.) (FIG. 1B). In this manner, as with the application agent 112, data analysis is completed by the PaaS agent 116 locally to distribute the processing involved in the analysis and promote more rapid analysis of the transfer data at the data source.

As an example, when the one or more rules applied by the PaaS agent 116 include remediation rules, the PaaS agent 116 may alter its operation to provide a safe operational state by, for example, provisioning additional resources for an execute queue via dynamic re-configuration, or setting a state which prevents future requests to be routed to the concerned instances, etc. Again in this example, the provisioning is limited to the computing device 200 in which the PaaS agent 116 is deployed, but is published to the provider backend PaaS collector 118 to permit patterns of events and actions to be observed and rules relating to the remedial action to be dynamically altered in response thereto, as desired.

The IaaS agent 120 of the service provider backend system 110 is deployed in association with infrastructure level systems, such as, for example, servers, load-balancers, storage devices, etc. The IaaS agent 120 generates time series metrics that may include, without limitation, covering resource utilizations, etc. Again, other metrics may be generated by the IaaS agent 120 based on infrastructure level activities/performances, etc. as desired. The IaaS agent 120 also raises (or generates) IaaS events, when unsafe states/conditions exist, such as, for example, ENOMEM events indicating out of memory state, Error Multiple File (EMFILE) events indicating too many open files, etc.

The generated metrics and/or events are captured by the IaaS agent 120, and again aggregated along flexible, learned time intervals based on observed metrics. In addition, the generated metrics and/or events are correlated by the IaaS agent 120 by defining statistically significant dependencies and relationships between one or more sets of the metrics and/or the events. The IaaS agent 120 then analyzes and detects variances and anomalies in the metrics and/or events over the time intervals based on statistical analysis, with dynamic thresholds again computed through observed metric streams for the given class of infrastructure.

The data from the aggregation and correlation of the generated metrics and/or events is next checked, by the IaaS agent 120, against one or more rules (again, e.g., sampling rules, remediation rules, notification rules, etc.). The IaaS agent 120 samples the data and publishes the sampled data to the provider backend IaaS collector 122 of the processing engine 128 (e.g., via the computing devices 200, etc.) (FIG. 1B). In this manner, as with the PaaS agent 116 (and others), the data analysis is completed locally to distribute the processing involved in the analysis and promote more rapid analysis of the transfer data.

As an example, when the one or more rules applied by the IaaS agent 120 include remediation rules, the IaaS agent 120 may alter its operation to bring a component in question to a safe operational state by, for example, re-booting when a ENOMEM event is detected, etc. Again in this example, bringing the component in question to the safe operational state is limited to the computing device 200 of the IaaS agent 120, but is published to the provider backend IaaS collector 122 to permit patterns of events and actions to be observed and the rules relating to the remedial action to be dynamically altered in response thereto, as desired.

At this point it is noted that, while the system 100 includes agents 102, 106, 112, 116, 120, etc. associated with commercial networks, devices, and the service provider backend system 110, it should be appreciated that other agents may further be deployed within the system 100, or within one or more variations of the system 100. Such agents would function substantially consistent with the agents described above, yet may generate one or more of the same or different types of metrics and/or events based on the same or different data, and/or may utilize one or more of the same or different rules associated with such metrics and/or events.

With continued reference to FIG. 1C, the partner network 138 of the system 100 may include, as previously described, any external system(s) with which a service provider network communicates and/or integrates. For example, the partner network 138 may include one or more of a card processor network system, an issuer network system, an acquirer network system, a combination thereof, etc. In addition, the partner network 138 can be integrated with the service provider network on pre-defined endpoints, which are configured into the network(s) with alternatives available for business function support, as well as network quality support (e.g., high availability options, etc.). Here, the partner network 138, while often not controlled by the service provider of the system 100, can be measured for performance at the edges where integration between the partner network 138 and the service provider occurs (each individual entity is treated as a data collection point to the service provider backend system 110, but not more). In at least one alternative embodiment, one or more entities of the partner network 138 permits the incorporation of a partner agent, suitable to perform substantially similar operations/functions to the agents 102, 106, 112, 116, 120, etc. described above.

The edge routing and switching collector 124 of the service provider backend system 110 is associated with the partner network 138. The collector 124 is substantially dedicated to traffic modeling and metrics variance detection for incoming and outgoing traffic to/from the service provider backend system 110. The collector 124 is configured to identify the possible endpoints from which partner network traffic is routed for a particular business context (e.g., it is aware of issuers, processors, and acquirers that service a particular geographic region; routing rules for network traffic; routing rates for each end-point, which is a valid recipient of a particular transaction; etc.). The collector 124 then generates, as desired, metrics including, for example, response time metrics, throughput rate metrics, error and/or failure rate metrics, etc., and/or events such as network reachability events, etc. Other metrics and/or events may be generated or captured by the collector 124, as desired, potentially depending on the type of the partner network 138 (or entities included therein, etc.), the position/location of the end-point(s) associated with the partner network 138, etc.

In any case, the generated metrics and/or events are captured, by the collector 124, and again aggregated along flexible, learned time intervals based on observed metrics. In addition, the collector 124 correlates the metrics and/or events over the flexible moving time intervals, which involves, for example, determining statistically significant dependences and relationships between one or more sets of the metrics, and/or the events, based on the sampled data from the agents. It should be appreciated that the collector 124 may determine one or more dependencies and/or relationship based on less than all the data from an agent or multiple agents, i.e., based on sampled data (in whole or in part), but not other data received from the agent. The collector 124 then analyzes and detects variances in the metrics and/or the events over the time intervals based on statistical analysis, with dynamic thresholds again computed through observed metric streams for the given class of infrastructure.

The data from the aggregation and correlation of the generated metrics and/or events is next subjected to rules, by the collector 124, that, like above, include (without limitation) sampling rules, remediation rules, notification rules, etc. When the rules include remediation rules, the collector 124 may, in order to address an observed variance, route a transaction to an alternate end-point of the partner network 138 (for the partner at issue), select a different (but still valid) route for a transaction (e.g., when a certain part of the acquirer network system is subject to maintenance, etc.), etc. Further, based on one or more of the rules, the collector 124 may also publish sampled data (e.g., when the rules include sampling rules, etc.) to the backend partner integration collector 126 of the processing engine 128 (via computing devices 200, etc.) (FIG. 1B).

Referring again to FIG. 1B, as previously described, the processing engine 128 includes the collectors 104, 108, 114, 118, 122, and 126 for each of the agents 102, 106, 112, 116, and 120 (and for the collector 124) of the service provider backend system 110. Specifically, the network collector 104 is associated with one or more of the network agents 102; the device collector 108 is associated with one or more the device agents 106; the backend application collector 114 is associated with the applications agent 112; the backend PaaS collector 118 is associated with the PaaS agent 116; and the backend IaaS collector 122 is associated with the IaaS agent 120. In addition, the backend partner integration collector 126 is associated with the edge routing and switching collector 124.

As shown, the collectors 104, 108, 114, 118, 122, and 126 may be associated with one, multiple or all agents of a particular type and/or within a particular region. In embodiments in which a large number of agents are associated with a particular collector, the collector, at any given time, may be leveraging a stream processing capability. Here, temporally aggregated data samples, enriched events, and actions performed are received at the collector from its associated agents. The collector then provides a spatial aggregation and statistical analysis that includes tracking moving averages across multiple dimensions. In one particular example, a moving average over one dimension, such as, for example, a country where the transaction occurred, may be compared to a moving average over another dimension, such as, for example, a processor used for that transaction. Where comparing all dimensions is not suitable (e.g., due to large numbers of dimensions, etc.), particular dimensions of interest within a domain may be selected based on a business domain context. In addition in these embodiments, the collector also leverages richer statistical algorithms to determine variances across the system 100 and to create content aware clusters in real time across all or certain types and classes of agents and metrics associated therewith. The clusters generally include grouped metrics and/or events such that the metrics and/or events, in a cluster (or set), are more similar to each other than to metrics and/or events in other clusters (or sets) (e.g., transaction counts versus CPU utilization—two separate clusters, etc.). Clusters can be based on relationships between metrics and, in some embodiments, metadata can be added to the metrics of interest and the dimensions available in the data. In one example, for transaction count and payment size range metrics, emitted by a payment processing application, a dimension of interest may be the country (or region) for the transaction source, and another may be the currency. A content aware cluster may be one that has metrics for any processing that is happening in a particular country (or region). The same metrics and the same dimension may also be present in another cluster where the “content” is the currency dimension. At a coarse level, the content would be by data “qualities” (e.g. sparse dimensional data, etc.) at one cluster, and “dense” time series data would be another.

In these embodiments, data from the analysis can further be sampled and published into the processing engine 128. The data is also persisted to memory, including, for example, a high performance read-write optimized memory data-grid. High performance read-write optimized data grids are provided, in several embodiments, to spread data over a number of memories associated with different devices in the system 100 (or other devices used, by the system 100, for data storage), whereby the data is accessed (i.e., read-write operations) in parallel fashion, which permits either a lot of data to be read efficiently or a lot of data to be written to the database efficiently. For purposes of illustration only, a lot of data, in the exemplary embodiment, may include data sets with 1,000s, 10,000's, or 100,000's of records; in which each record includes one or multiple attributes, even 10's of attributes or more, etc. Data, by the collectors (e.g., collectors 104, 108, 114, 118, 122, 226; etc.) or by the processing engine 128, may then be stored in the distributed storage. In various aspects, the collectors further support a continuous query, such that the collectors enable real time views to be streamed to an operator dashboard and/or fed into additional algorithms. The continuous query permits the processing engine 128 to gather published data, but only new published data since the last query.

As shown in FIG. 1B, the processing engine 128, and/or any of its collectors 104, 108, 114, 118, 122, and 126, collects, analyzes, and observes patterns in the enriched metric and/or event samples published to the processing engine 128 from the various collectors 104, 108, 114, 118, 122, and 126. As an example, the processing engine 128 performs real-time continuous regression analytics on the events published from the network agents 102 and the device agents 106, via the collectors 104, 108, 114, 118, 122, and 126, leveraging continuous query capabilities and the data in the event stream(s). Such continuous queries permit the processing engine 128 to register the queries with a computing device and return the result set, and also continuously evaluate the queries again and update the processing engine 128 with the additional results. In some aspects, based on the regression analysis and/or the observed dependencies and/or correlations, and heuristics (as described above), the processing engine 128 performs predictive analytics on the event stream(s). Such predictive analytics generally implicate the use of data to pre-determine patterns in the data that indicate causal relationships between metrics and/or events and, as such, a variance where a particular pattern exists. The processing engine 128 is then configured to predict, based on the pattern occurring within the event stream(s)/data set(s), the future metrics and/or events, and thus the variance(s). Such analysis provides a proactive mechanism to detect variances.

In some aspects, based on the predictive analysis, the processing engine 128 determines whether or not to alter the rules associated with remediation use at the network agents 102 and/or device agents 106. Once it is determined that a variance is about to occur, the processing engine 128 is capable of taking action to prevent the variance from happening. In one example, when a CPU load of a computing device is seen to be spiking due to lack of proper garbage collection and has, in the past, lead to failures in a server, the processing engine 128, though a remediation rule, causes automatic restart of the computing device (e.g., one or more computing device 200 in system 100, etc.) containing the CPU, thereby clearing the memory issues and restoring the computing device back to health before it crashes.

In particular, where any of the agents 102, 106, 112, 116, and 120 (and the collector 124) of the system, described above, alter rules and/or implement remedial action only for the computing device 200 in which the particular agent is deployed, the processing engine 128 is permitted to alter the rules/actions of the computing device 200, at the device 200, at the commercial network and at the service provider backend system level. In one example, the processing engine 128 may append a rule to the remediation rules to prompt a user to download a latest version of an application in response to multiple error requests. In another example, the processing engine 128 may append a rule to the remediation rules to route data transfer away from a certain part or agent of the system 100 or toward a part or agent of the system 100 based on volume, maintenance, or other factors, etc. In yet another example, the processing engine 128 may append a rule to the remediation rules to take no action when a user device is connected via a 2G network. With that said, it should be appreciated that any number and/or type of rules may be added, to the sampling, remediation or notification rules, based on the analysis performed by the processing engine 128.

As also shown in FIG. 1B, data from the analysis (from the network collector 104, from the device collector 108, from the processing engine 128, etc.) is then persisted to the high performance read-write optimized in memory data grid 130, and further hydrated to the distributed file system 132.

With reference now to FIG. 1D, the regional processing engines 136 of the system 100 each include (e.g., are illustrated as implemented in, etc.) a computing device 200. The regional processing engines 136 are substantially similar to the processing engine 128, but are limited to a particular region, such as for example, a particular country or territory. Each of the regional processing engines 136, like the processing engine 128, observes dependencies and causal correlations between metrics and/or events from different computing devices 200 within the region, and at different levels within the regional system. The regional processing engines 136 perform regression analysis, often continuously, on the metrics and/or events generated within the associated regions. In some aspects, the regional processing engines 136 employ continuous query capabilities on the metric and/or events reported from within the regions to continually add only new data to their analysis. As such, the regional processing engines 136, based on the regression analysis, the observed dependencies, the correlations, and/or the heuristics discussed herein, can perform predictive analytics on the metrics and/or events generated within the regions. The regional processing engines 136 can further alter rules (or propose updates to rules) around remediation at the various end-points in their regional systems. The altered rules, sampled data, and/or analysis may be stored and/or published, by the regional processing engines 136, to the high performance read-write optimized in memory data grid 130 (FIG. 1B), or to one or more or different memory, such as, for example, distributed memory, etc. Sampled and other data may further be provided to one or more components/entities of the system 100 (or others) to perform additional analysis thereon.

In the illustrated embodiment, the regional processing engines 136 feed certain sampled data to the processing engine 128 and further receive sampling, action and/or remediation rules from the processing engine 128. For example, the processing engine 128, like with certain ones of the agents 102, 106, 112, 116, 120, etc., can provide action rules to one or more of the regional processing engines 136, where a system degradation is expected due to observed spikes in volume correlated to a capabilities rollout and/or an event in one geo-location. In addition, even though the regional processing engines 136 may be limited or separate, the regional processing engines 136 receive certain rules, in this embodiment, to promote efficient operation of the system 100, especially where the system activity within the particular regions of the regional processing engines 136 impacts other regions.

As indicated above, the system 100 is implemented in a payment network for processing payment transactions, often to payment accounts. In such a payment network, typically, merchants, acquirers, payment service providers, and issuers cooperate, in response to requests from consumers, to complete payment transactions for goods/services, such as credit transactions, etc. As such, in the system 100, the device agents 106 are deployed at point of sale terminals, mobile purchase applications, merchant web servers, etc., in connection with the merchants, while the commercial network agents 102 are deployed within one or more commercial network computing device (e.g., a server, etc.) between the merchants and/or consumers and the service provider backend system 110, which may be at one location or distributed across several locations. The edge routing and switching collector 124 may further interface with the issuers, the acquirers, and/or other processors of the transactions to the payment network.

As an example, in a credit transaction in the system 100, the merchant, often the merchant's computing device, reads a payment device (e.g., MasterCard® payment devices, etc.) presented by a consumer, and transmits an authorization request, which includes a primary account number (PAN) for a payment account associated with the consumer's payment device and an amount of a purchase in the transaction, to the acquirer through one or more commercial networks. The acquirer, in turn, communicates with the issuer through the payment service provider, such as, for example, the MasterCard® interchange, for authorization to complete the transaction. In particular, a part of the PAN, i.e., the BIN, identifies the issuer, and permits the acquirer and/or payment service provider to route the authorization request, through the one or more commercial networks, to the particular issuer. The acquirer and/or the payment service provider then handle the authorization, and ultimately the clearing of the transaction, in accordance with known processes. If the issuer accepts the transaction, an authorization reply is provided back to the merchant, and the merchant completes the transaction. The transaction is posted to the payment account associated with the consumer. The transaction is later settled by and between the merchant, the acquirer, and the issuer.

In other exemplary embodiments, a transaction may further include the use of a personal identification number (PIN) authorization, or a ZIP code associated with the payment account, or other steps associated with identifying a payment account and/or authenticating the consumer, etc. In some transactions, the acquirer and the issuer communicate directly, apart from the payment service provider. With that said, it should be appreciated that any of the data transfers within the credit transaction described above, and variations thereof, may be the data transfer from which the metrics and/or events are generated and/or captured as described herein.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the steps recited in the claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements, and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for use in proactively remediating payment network degradation, the method comprising:
collecting, by a processing engine, new sampled data and variances in the new sampled data, from multiple agents deployed in a network, in response to a data query, the sampled data including response time data and/or resource utilization data, the multiple agents remote from the processing engine, wherein the new sampled data is indicative of performance of the network and utilization of devices connected to the network, and wherein the new sampled data is new since a last data query, whereby the new sampled data and the variances are collected from the multiple agents to which processing of the data is distributed;
determining, by the processing engine, at least one dependency between sets of metrics and/or events in the new sampled data from at least one of the multiple agents;
performing, by the processing engine, real-time continuous regression analysis on the new sampled data;
predicting, by the processing engine, through predictive analytics on the at least one dependency and the real-time continuous regression analysis, at least one future variance associated with the network based on a pattern occurring in the new sampled data;
altering, by the processing engine, a remediation rule based on the predicted at least one future variance, the remediation rule indicating at least one action to be taken by at least one of the multiple agents from which the new sampled data was collected in order to address the predicted at least one future variance; and
transmitting, by the processing engine, the remediation rule to the at least one of the multiple agents from which the new sampled data was collected, whereby the at least one of the multiple agents receives the remediation rule and is permitted to address the predicted at least one future variance based on the remediation rule.

2. The method of claim 1, further comprising deploying the multiple agents to each of multiple computing devices associated with the network.

3. The method of claim 1, wherein collecting the new sampled data includes collecting the new sampled data and other data from the multiple agents, via at least one collector; and
wherein the at least one dependency is not based on the other data.

4. The method of claim 1, wherein collecting the new sampled data includes:
receiving, by a collector from the multiple agents, data related to payment transactions;
aggregating, by the collector, based on time and/or distribution of the multiple agents, the data, events received from at least some of the multiple agents, and/or a remedial action associated with at least one of the multiple agents;
determining, by the collector, at least one variance based on at least one of the events received from the multiple agents; and
publishing, by the collector to the processing engine, the at least one variance and the sampled data.

5. The method of claim 1, further comprising creating content aware clusters across multiple types and/or classes of the multiple agents and metrics associated with said multiple agents.

6. The method of claim 1, wherein altering the remediation rule includes appending the remediation rule to a set of remediation rules, said remediation rule directing at least one of the multiple agents to route transaction data away from one or more other of multiple agents.

7. The method of claim 2, wherein each of the multiple computing devices is a point of sale terminal.

8. A system for use in proactively remediating payment network degradation, the system comprising:
one or more computing devices for connection to multiple agents deployed in association with a payment network, wherein the multiple agents are geographically distributed from the one or more computing devices, wherein the sampled data is related to payment transactions processed by the payment network, and wherein the one or more computing devices include computer executable instructions embodied therein defining at least one collector and a processing engine;
wherein the at least one collector is configured to:
receive, from the multiple agents, the sampled data relating to the payment transactions, the sampled data including response time data and/or resource utilization data; and
provide at least a portion of the sampled data to the processing engine; and
wherein the processing engine is configured to:
determine at least one dependency between sets of metrics and/or events in the sampled data received from the at least one collector;
perform real-time continuous regression analysis on the sampled data;
predict, through predictive analytics on the at least one dependency and the real-time continuous regression analysis, at least one future variance associated with the payment network based on a pattern occurring in the sampled data;
alter a remediation rule based on the predicated at least one future variance, the remediation rule indicating at least one action to be taken by at least one of the multiple agents in order to address the predicted at least one future variance; and
transmit the remediation rule to at least one of the multiple agents.

9. The system of claim 8, wherein the at least one collector is further configured to:
aggregate the sampled data, at least one event received from the multiple agents, and at least one remedial action associated with at least one of the multiple agents; and
determine at least one variance based on regression analysis of the sampled data and at least one of the at least one event and the at least one remedial action; and
wherein the at least a portion of the sampled data includes the at least one variance and the aggregated sampled data associated with the at least one variance; and
wherein the at least one dependency is based on the at least one variance.

10. The system of claim 9, wherein the at least one collector is configured to aggregate the sampled data based on time and/or distribution of the multiple agents.

11. The system of claim 9, wherein the one or more computing devices include a distributed storage memory data grid;
wherein the at least one collector is configured to store the aggregated sampled data in the distributed storage memory data grid.

12. A computer-implemented method for use in proactively remediating payment network degradation in a payment network, the payment network including multiple computing devices distributed across a geographic region, the method comprising:
receiving, by a collector computing device, sampled data relating to payment transactions, from multiple agents deployed in association with the payment network, the sampled data including response time data and/or resource utilization data, the multiple agents including an application agent, a Platform as a Service (PaaS) agent, and an Infrastructure as a Service (IaaS) agent;
aggregating, by the collector computing device, based on learned time intervals and distribution of the multiple agents, the sampled data, events received from at least some of the multiple agents, and a remedial action associated with at least one of the multiple agents;
determining, at the collector computing device, at least one variance based on at least one of the events over the learned time intervals; and
publishing, to a processing engine, the at least one variance and the aggregated data, whereby the processing engine receives the published at least one variance and the aggregated data to perform predictive analytics and determine whether to alter a remedial rule for use by at least one of the multiple agents to determine an action to address a detected variance based on the remedial rule.

13. The computer-implemented method of claim 12, further comprising storing the at least one variance and/or the aggregated data in a distributed storage memory data grid.

14. The computer-implemented method of claim 12, further comprising creating content aware clusters across multiple types and/or classes of the multiple agents and metrics associated with said multiple agents.

15. The computer-implemented method of claim 12, wherein receiving the sampled data includes receiving only new sampled data, in response to a data query, the new sampled data being new since a last data query; and
wherein the method further comprises causing, by the processing engine, at least one of the multiple agents to perform a remedial action based on the sampled data and at least one remediation rule.

16. The computer-implemented method of claim 12, wherein the collector includes a device collector associated with multiple device agents; and
wherein each of the multiple device agents is deployed in a point of sale device.

17. The computer-implemented method of claim 12, wherein the collector includes a device collector associated with multiple network agents; and
wherein each of the multiple network agents is deployed in a commercial network server.
